(19) United States
(12) Patent Application Publication
(10) Pub. No.: US 2011/0219022 A1
(43) Pub. Date: Sep. 8, 2011

(54) MANAGEMENT APPARATUS AND DATA PROCESSING METHOD FOR MAINTENANCE SYSTEM

(75) Inventors: Yoshikatsu Kamisuwa, Tokyo-to (JP); Hiroyo Katou, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/038,704

(22) Filed: Mar. 2, 2011

Related U.S. Application Data
(60) Provisional application No. 61/309,942, filed on Mar. 3, 2010.

(51) Int. Cl. G06F 17/30

(52) U.S. Cl. 707/769; 707/E17.014; 707/E17.044

(57) ABSTRACT

According to one embodiment, a management apparatus includes an information acquisition unit, an information supply unit, a transmission processing unit, and an analysis unit. The information acquisition unit stores detailed data acquired from image processing apparatuses to be managed in an database. The information supply unit outputs data extracted from the database and data extracted from an analysis result database storing an analysis result of log data in response to a supply request of information regarding the image processing apparatus to be managed. The transmission processing unit stores the detailed data stored in the database as the log data of the image processing apparatuses in a log database asynchronously with the supply request of the information. The analysis unit analyzes the log data stored in the log database asynchronously with the supply request of the information and storing the analysis result in the analysis result database.

### CROSS-REFERENCE TO RELATED APPLICATIONS

This application is based upon and claims the benefit of priority from U.S. Provisional Application No. 61/309,942 filed on Mar. 3, 2010; the entire contents of which are incorporated herein by reference.

### FIELD

Embodiments described herein relate generally to a management apparatus managing an image processing apparatus, a management system, and a data processing method for a maintenance system.

### BACKGROUND

A maintenance system remotely manages the activation status of an image processing apparatus such as a digital multi function peripheral and supplies information regarding maintenance work. However, in terms of actual applicability, there are various kinds of maintenance systems in the scale or activation state of the entire system. Therefore, it is not easy to construct the maintenance system capable of efficiently executing data communication and data processing.

### BRIEF DESCRIPTION OF THE DRAWINGS

FIG. 1 is a diagram illustrating the overall configuration of a maintenance system.

FIG. 2 is a block diagram illustrating an exemplary configuration of a control system of a digital multi function peripheral.

FIG. 3 is a diagram illustrating an example of information supplied by the maintenance system.

FIG. 4 is a flowchart illustrating a processing flow in an information supply server.

FIG. 5 is a flowchart illustrating a processing flow in an analysis server.

### DETAILED DESCRIPTION

In general, according to one embodiment, a management apparatus includes an information acquisition unit, an information supply unit, a transmission processing unit, and an analysis unit. The information acquisition unit stores detailed data acquired from an image processing apparatus to be managed in an database. The information supply unit outputs data extracted from the database and data extracted from an analysis result database storing analysis result of log data in response to a supply request of information regarding the image processing apparatus to be managed. The transmission processing unit stores the detailed data stored in the database as log data of the image processing apparatus in the log database asynchronously with the supply request of the information. The analysis unit analyzes the log data stored in the log database asynchronously with the supply request of the information and stores the analysis result in the analysis result database.

Hereinafter, an embodiment of the invention will be described in detail with reference to the drawings.

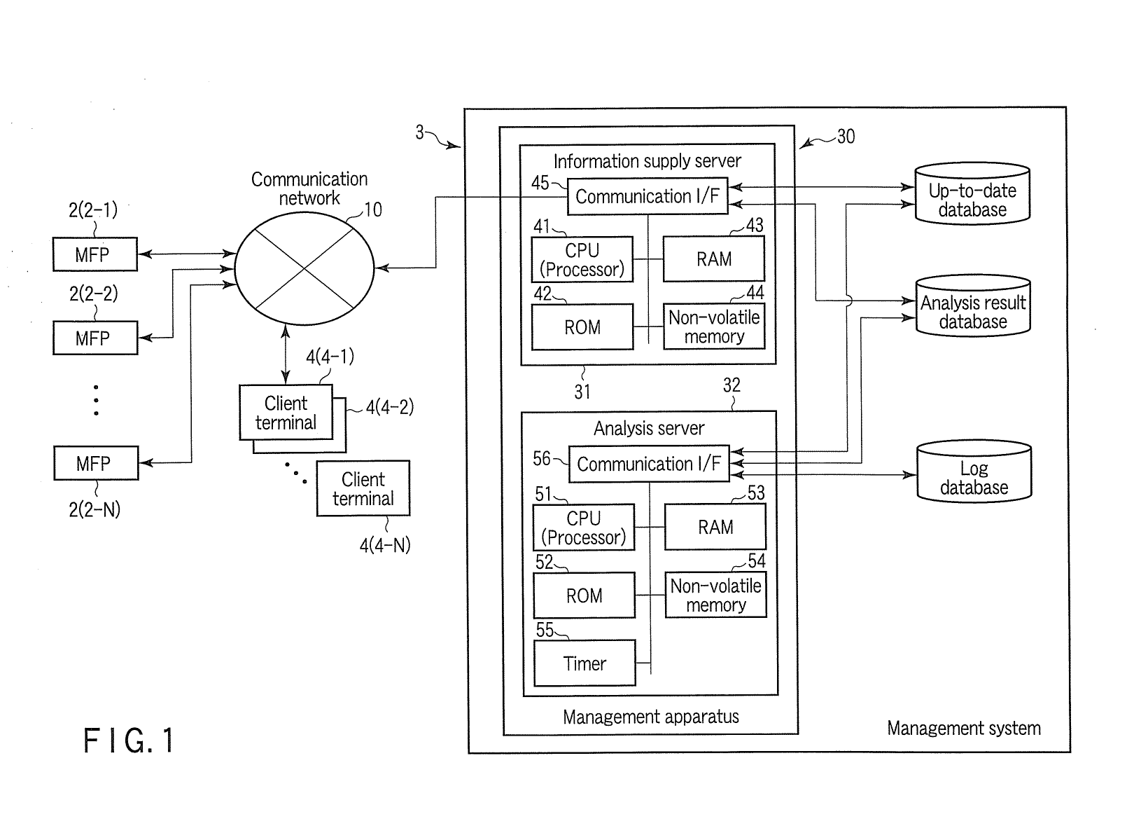

FIG. 1 is a diagram illustrating an overview of a maintenance system of image processing apparatuses according to this embodiment.

The maintenance system shown in FIG. 1 is a system in which a plurality of digital multi function peripherals (MFPs) 2, which are image processing apparatuses (image forming apparatuses), and a management system 3 are connected to each other through a communication network 10. Client terminals 4 are connected to the communication network 10. The client terminal 4 is a terminal apparatus which is operated by a service operative who repairs or checks the MFP. For example, the client terminal 4 is configured by a personal computer which includes a display device.

The digital multi function peripheral 2 has a copy function, a scanner function, a printer function, or various kinds of data communication functions. For example, the digital multi function peripheral 2 may be an apparatus processing an image or a copy apparatus having only a copy function. Alternatively, the digital multi function peripheral 2 may be an apparatus having only a scanner function or only a printer function. Alternatively, the digital multi function peripheral 2 may have a function of receiving an image by FAX, a function of receiving an image by e-mail, a function of receiving a print image by a network, and the like, as well as the copy function. The management system 3 has a function of managing maintenance work of a service operative of each digital multi function peripheral 2 in the maintenance system.

In this embodiment, the digital multi function peripheral 2 transmits data (which is detailed data described below) indicating a usage state to the management system 3 via the communication network 10. The digital multi function peripheral 2 periodically transmits the detailed data. For example, the digital multi function peripheral 2 transmits the detailed data at every predetermined time (for example, every set period of each day). The digital multi function peripheral 2 may transmit the detailed data if an event such as an error occurs as well as the periodic transmission. The digital multi function peripheral 2 accumulates the detailed data in a table provided in a non-volatile memory and transmits the detailed data extracted from the table at a desired transmission timing.

The detailed data is information used to grasp the MFP state (a usage state, a consumable goods state, an operation form, or the like) in detail. The detailed data includes information regarding the counter value of the number (for example, the total number of current printers) of various kinds of operations, information regarding the output value of each sensor, error information, customer information, log data, and the like in the MFP. If the digital multi function peripheral 2 includes an electro-photographic printer, the detailed data includes detection values of various types of sensors, such as the detection value of a sensor measuring the surface potential of a photoconductive drum serving as an image carrying member or the detection values of a temperature sensor and a humidity sensor measuring the internal temperature and humidity of a fixing member. Moreover, the detailed data may include the current life counter value (a counter value corresponding to a physical amount effective in grasping the deterioration degree of each consumable goods) of each of the consumable goods of the digital multi function peripheral.

Next, the configuration of the management system 3 will be described.

The management system 3 includes an information supply server 31, an analysis server 32, an up-to-date database 33, an analysis result database 34, and a log database 35.

The information supply server 31 and the analysis server 32 may be configured by separate server apparatuses or one server apparatus (management apparatus) 30. Moreover, the respective databases 33, 34, and 35 may be provided in the information supply server 31 or the analysis server 32. For example, the up-to-date database 33 may be provided in the information supply server 31. The analysis result database 34 may be provided in the information supply server 31 or the analysis server 32. The log database 35 may be provided in the analysis server 32.

Next, the configuration of the information supply server 31 will be described.

In an exemplary configuration shown in FIG. 1, the information supply server 31 includes a CPU (processor) 41, a ROM 42, a RAM 43, a non-volatile memory 44, and a communication interface 45.

For example, the CPU 41 is a processor. The CPU 41 is in charge of controlling the entire information supply server 31. The CPU 41 has a function of realizing various processing by executing programs. The ROM 42 stores a control program, control data, and the like. The RAM 43 functions as a working memory. The non-volatile memory 44 is a non-volatile memory which can be updated.

The communication interface 45 is an interface which executes data communication with the MFP 2 or the client terminal 4 via the communication network 10. The communication interface 45 also functions as an interface which executes communication within a local area network in the management system. Moreover, the information supply server 31 may be provided with an operation unit such as a keyboard or a mouse, a display device displaying information, or an interface connected to a printer which prints information on a medium such as a paper sheet.

The information supply server 31 having the above configuration has a function of collecting data from each MFP 2 and a function of supplying information such as maintenance information related to each MFP 2. That is, the information supply server 31 stores data acquired from each MFP 2 by data communication via the communication network 10 as up-to-date data in the up-to-date database 33. The information supply server 31 extracts information to be supplied in response to a request from the client terminal 4 from the up-to-date database 33 and the analysis result database 34 and supplies the extracted information to the client terminal 4.

The processing functions are realized by executing the programs stored in the ROM 42 or the non-volatile memory 44 by the CPU 41. The control program or the like to be executed as the function of the information supply server 31 by the CPU 41 is stored in the ROM 42 or the non-volatile memory 44. The program of an operating system (OS) executed by the CPU 41 is also stored in the ROM 42 or the non-volatile memory 44.

Moreover, the detailed data of the MFP may be input into the information supply server 31 by the operation of the service operative. In this case, the information supply server 31 can process the same data as the detailed data received via the communication network 10.

Next, the configuration of the analysis server 32 will be described.

In the exemplary configuration shown in FIG. 1, the analysis server 32 includes a CPU (processor) 51, a ROM 52, a RAM 53, a non-volatile memory 54, a timer 55, and a communication interface 56.

For example, the CPU 51 is a processor. The CPU 51 is in charge of controlling the entire analysis server 32. The CPU 51 has a function of realizing various data processing by executing programs. The ROM 52 is a non-volatile memory which stores a basic control program, control data, and the like. The RAM 53 is functioning as a working memory. The non-volatile memory 44 is a non-volatile memory which can be updated. The timer 55 is a timer which measures the current time.

The communication interface 56 is an interface which executes data communication via a network inside the management system. In the exemplary configuration shown in FIG. 1, the communication interface 56 of the analysis server 32 is an interface which can gain access to each of the databases 33, 34, and 35 without being connected to the external communication network 10.

The analysis server 32 having the above configuration has a function of managing the data stored in the up-to-date database 33 as log data and a function of analyzing maintenance information regarding each MFP from the log data. The analysis server 32 operates asynchronously with the information supply server 31. For example, the analysis server 32 collects the log data and analyzes the log data during an inactive time described below. The analysis server 32 accumulates the up-to-date data acquired from the MFPs 2 stored in the up-to-date database 33 as log data in the log database 35. The analysis server 32 analyzes the log data of each of the MFPs stored in the log database 35 to generate maintenance information regarding each MFP 2. The analysis server 32 stores the generated maintenance information as an analysis result in the analysis result database 34.

Such processing functions are realized by executing the programs stored in the ROM 52 or the non-volatile memory 54 by the CPU 51. The control program or the like to be executed as the function of the analysis server 32 by the CPU 51 is stored in the ROM 52 or the non-volatile memory 54. A program of an operating system (OS) having a task management function or the like executed by the CPU 51 is also stored in the ROM 52 or the non-volatile memory 54.

Next, the configuration of the MFP 2 will be described.

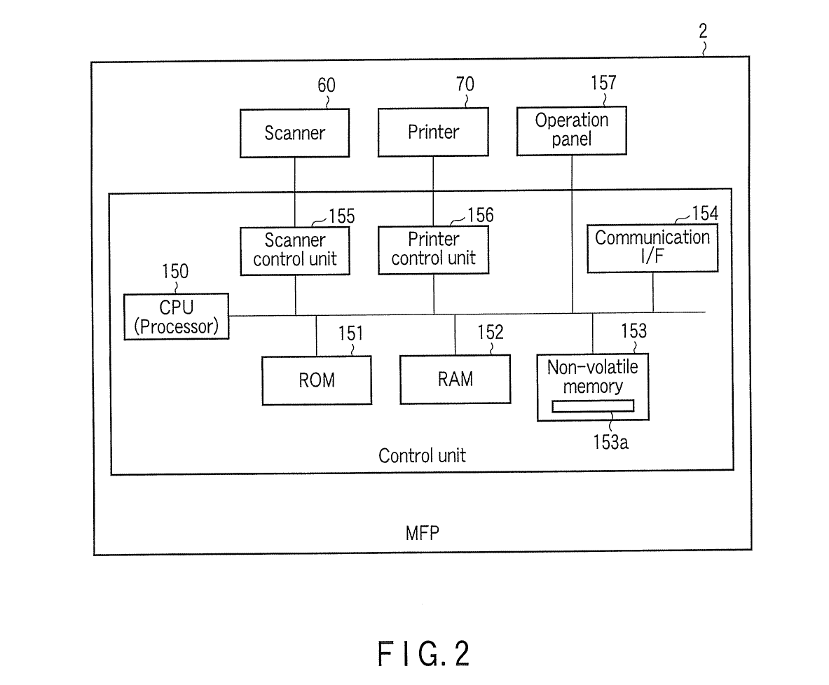

FIG. 2 is a block diagram illustrating an exemplary configuration of the MFP 2.

The MFP 2 includes a scanner 60, a printer 70 and a control unit 101. The scanner 60 reads an image of an original document. The printer 70 forms an image on a medium. The control unit 101 controls the entire MFP 2. For example, the control unit 101 controls copy processing by controlling the scanner 60 and the printer 70. The scanner 60 is an image reading apparatus having an automatic document feeder (ADF) which includes a pickup roller and a paper feeding roller. The printer 70 is, for example, an electro-photographic image forming apparatus. For example, the printer 70 includes a photoconductive drum, a charging member (including a charger), an exposure unit, a development unit, a transfer mechanism (including a transfer belt), a cleaner, a paper feeding mechanism (including a pickup roller, a paper feeding roller, and a separation roller), a transport mechanism (transport roller), and a fixing unit (including a fixing roller, a fixing belt, and a pressurization roller).

The control unit 101 includes a CPU (processor) 150, a ROM 151, a RAM 152, a non-volatile memory 153, a communication interface 154, a scanner control unit 155, and a printer control unit 156.

The CPU 150 is, for example, a processor. The CPU 150 is in charge of controlling the entire MFP 2. The CPU 150 executes various processing by executing the programs stored in the ROM 151 or the non-volatile memory 153. The ROM 151 stores a control program, control data, and the like. The RAM 152 is used as a working memory or a buffer memory. The non-volatile memory 153 is a non-volatile memory which can be updated. The non-volatile memory 153 stores the control program, the control data, and the like.

The non-volatile memory 153 has a state information table 153a storing a value indicating the usage state of the MFP 2. The state information table 153a stores data used as the detailed data. For example, the state information table 153a stores a counter value indicating the number of times printing is performed, a counter value indicating the number of times scanning is performed, a life counter value used to determine the life of each of the consumable goods, a value detected by each sensor disposed in the MFP 2, and the like.

The communication interface 154 is an interface used to communicate with an external apparatus. The communication interface 154 is an interface used to communicate with the management apparatus 30 via a network. The scanner control unit 155 controls the scanner 60 in accordance with an instruction from the CPU 150. The printer control unit 156 controls the printer 70 in accordance with an instruction from the CPU 150. An operation panel 157 is connected to the control unit 101. The operation panel 157 is a panel through which an operation instruction of a user is input. The operation panel 157 has a display unit and an operation key. For example, the operation panel 157 includes a display device having a touch panel and hard keys.

Next, information supplied as maintenance information for the MFP 2 will be described.

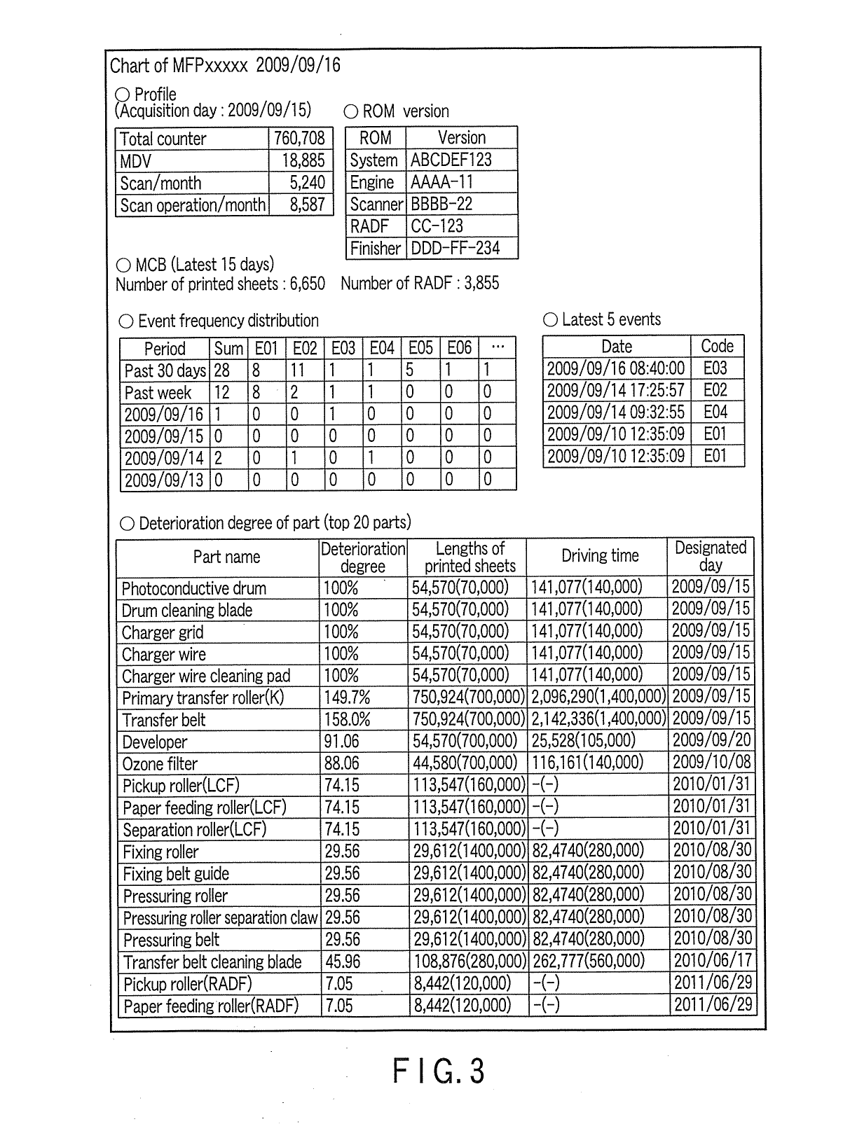

FIG. 3 is a diagram illustrating an exemplary configuration of a chart serving as the maintenance information for the MFP 2.

The chart shown in FIG. 3 is an example of the maintenance information supplied for a user. The information shown in FIG. 3 is output as a response to the request from the client terminal 4 (service operative). For example, the information shown in FIG. 3 is assumed to be display data to be displayed by the display device of the client terminal 4. The chart shown in FIG. 3 may be data printed on a paper sheet by the printer.

In the chart shown in FIG. 3, for example, the current total number of printed sheets, the average monthly number of printed sheets (MDV), and the like are shown. The current total number of printed sheets is included in the detailed data sent from the MFP 2. That is, the current total number of printed sheets can be extracted from the information stored as the up-to-date detailed data received from the MFP 2 in the up-to-date database 33. However, the average monthly number of printed sheets (MDV) is not the information included in the detailed data. As for the average monthly number of printed sheets, it is necessary to calculate monthly data using the past detailed data (log data). That is, the information supplied in the chart output in response to the request from the service operative includes various kinds of information such as the information necessary for the data processing, the information unnecessary for the data processing, the up-to-date value information, and information requiring the past data.

In the maintenance system according to this embodiment, the management system including the management apparatus separates the server processing information and the database storing information according to function. The management system separates processing executed during an active communication time (active time) in which the communication with the MFP 2 or the client terminals 4 is active from processing executed during the other time (inactive time). Thus, the maintenance system can efficiently process data without configuring a large sale system configuration. As a consequence, the maintenance system can efficiently supply information in a short response time.

That is, the information supply server responds to the request from the service operative in real time through the client terminal and supplies the information corresponding to the request. In general, the maintenance system managing the plurality of MFPs stores a great amount of log data. Therefore, it takes some time to extract (retrieve) necessary data from the log data. Moreover, it takes a lot of time to process heavy data including statistical analysis. If many processing requests occur simultaneously, the server may not process the processing requests due to its limited processing capability. Therefore, in the maintenance system, in order to respond to the requests quickly, the information supply server only extracts data from the up-to-date database and the analysis result database and executes simple data processing (format conversion or the like) without processing heavy data to supply information in response to the requests.

Next, an operation during the active communication time will be described.

In the maintenance system, there is a time (active time) in which data communication is actively executed and a time (inactive time) in which data communication is inactively executed. In this embodiment, it is assumed that the working hours correspond to the active time and nighttime corresponds to the inactive time.

In general, the service operative repairing the MFP works during the working hours (daily working hours). Thus, in the maintenance system, data communication occurring due to the request from the service operative is actively executed during the working hours.

In an office setting environment, the MFP 2 is turned on during the working hours (generally, daily working hours) of users in an office. During a time (for example, nighttime) other than the working hours, the MFP 2 is turned off. Here, it is assumed that the data communication is not executed while the MFP 2 is turned off. In this case, the data communication from the MFP 2 to the management apparatus 30 is also executed during the working hours of the users using the MFP 2. For example, periodic communication of the detailed data from the MFP 2 to the management system 3 is set to be executed at a periodic communication time during the daily working hours which are the working hours of the users.

For the above-mentioned reason, the working hours is set to be the active time and nighttime is set to be the inactive time in the maintenance system according to this embodiment. In the maintenance system, the management system 3 collects data from each MFP 2 and responds the request from the service operative during the active time. In addition, during the active time, the management system 3 does not execute data processing such as analysis of the collected data or retrieval of the log data. On the other hand, during the inactive time, the management system 3 accumulates the log data and executes data processing such as retrieval and analysis of the log data.

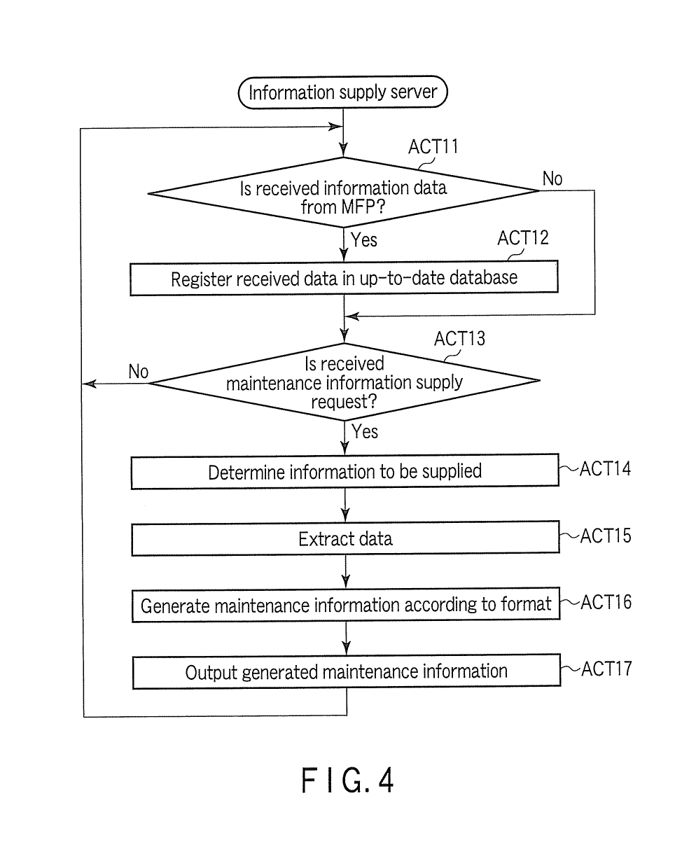

FIG. 4 is a flowchart illustrating a processing flow of the information supply server 31.

During the active time, the management system 3 collects data through the information supply server 31 and supplies information in response to an information supply request. That is, in the management system 3, the analysis server 32 does not collect the log data and analyzes the data during the active time.

The information supply server 31 of the management system 3 receives the detailed data from each MFP 2 or the information supply request or the like from the client terminal 4 via the communication network 10 through the communication interface 46. The CPU 41 of the information supply server 31 determines whether the received information is the detailed data from the MFP 2 or the information supply request from the client terminal 4, if the information supply server 31 receives the information through the communication interface 46 (Act 11 and Act 13).

If the information supply server 31 receives the detailed data from the MFP 2 through the communication interface 46 (YES in Act 11), the CPU 41 of the information supply server 31 registers the received detailed data as up-to-date data by matching the detailed data with information (for example, the apparatus ID of the MFP) indicating the corresponding MFP 2 in the up-to-date database 21 (Act 12). In this case, the CPU 41 may delete the past detailed data on the corresponding MFP by overwriting the past detailed data with the up-to-date data. Moreover, the detailed data stored in the up-to-date database 33 may be stored until the detailed data is transmitted to the log database 35 by processing described below. In this case, if the analysis server 32 executes transmission processing described below, the analysis server 32 may delete the data other than the up-to-date detailed data for each MFP in the up-to-date database 33.

If the information supply server 31 receives the information supply request from the client terminal through the communication interface 46 (YES in Act 13), the CPU 41 of the information supply server 31 determines an item of the data to be supplied and the format of the information to be supplied according to the content of the received request (Act 14). Here, it is assumed that the data to be supplied is information extracted from the up-to-date database 33 or the analysis result database 34. Moreover, it is assumed that the items of the data and the format of the data to be supplied are set in advance according to the content of the request.

If the items of the data to be supplied are determined, the CPU 41 extracts data to be supplied, from the up-to-date database 33 or the analysis result database 34 (Act 15). If the data to be supplied is extracted, the CPU 41 generates information (for example, display information shown in FIG. 3) to be supplied in response to the request by processing the extracted data so as to have the format of the data according to the request (Act 16). For example, if a display chart shown in FIG. 3 is requested, the CPU 41 extracts data regarding the MFP 2 to be processed from the up-to-date database 33 and the analysis result database 34 and processes the extracted data so as to have the display format shown in FIG. 3. If the information to be supplied is generated in response to the request, the CPU 41 transmits (supplies) the generated information to the client terminal 4, which is a source transmitting the request, through the communication interface 46 (Act 17).

According to the processing described above, the information supply server generates the information to be supplied to the client terminal by extracting the information to be supplied to the client terminal from the generated analysis result registered in the analysis result database and the up-to-date information registered in the up-to-date database and converting the extracted information so as to have the format according to the request of the client terminal. Thus, the information supply server can generate the information to be supplied in response to the request through the process of extracting the data from the databases 33 and 34 and the simple process of converting the format, and thus can respond in response to the information supply request in a short time.

That is, a lot of information with the up-to-date data to be supplied in response to the request is just extracted without change. Therefore, the information to be supplied in response to the request can be extracted not from the log database storing the past vast log data but from the up-to-date database storing only the up-to-date data (for example, the up-to-date data corresponding to several days). As a consequence, the information supply server can extract the necessary data in a short data retrieval time.

Moreover, the data analysis including complicated data processing is executed by the separate analysis server 32. The analysis result of the analysis server is stored in the analysis result database. Thus, the information supply server just extracts the necessary data from the analysis result database without executing actual data processing in response to the request (synchronously with the request), even if data necessary to be processed by complicated data processing is included in the information to be supplied in response to the request. As a consequence, the information supply server can supply the information or the like obtained through data analysis in a short time.

Next, an operation during the inactive communication time will be described.

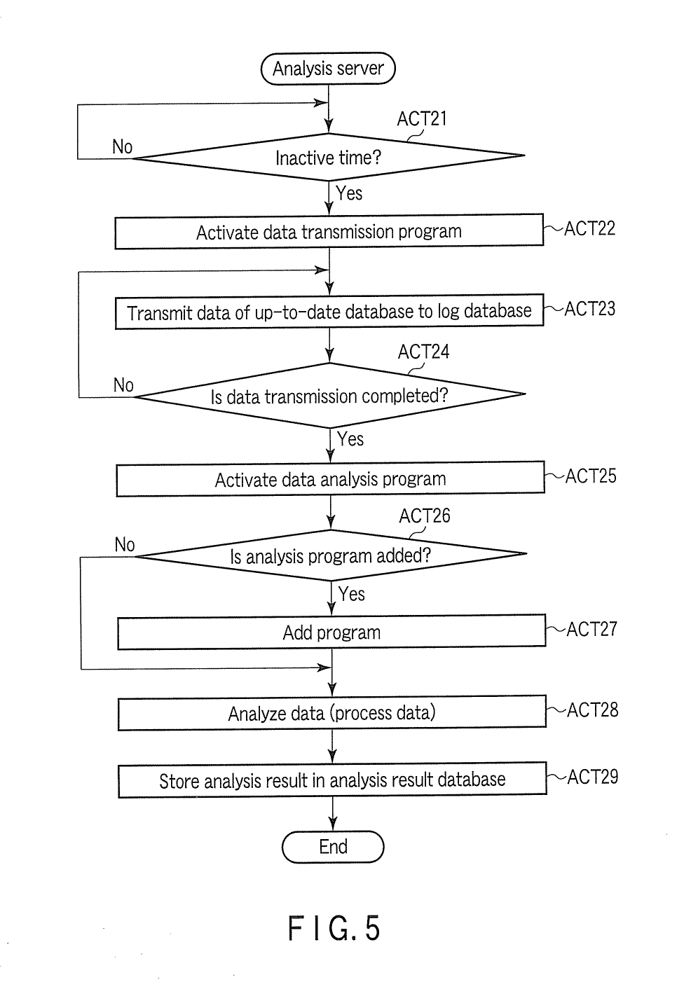

FIG. 5 is a flowchart illustrating an operation flow during the inactive communication time.

As described above, it is assumed that the inactive time is nighttime. For example, if the inactive time (for example, late at night at 0:00 AM) comes, the analysis server 32 automatically starts processing by a task management function of an operating system (OS) executed by the CPU 51. Even during the inactive time, the processing of the information supply server 31 may continue to be executed.

If a time measured by the timer 55 becomes the inactive time (YES in Act 21), the CPU 51 of the analysis server 32 activates a data transmission program to execute a processing function of the analysis server 32 (Act 22). By the transmission processing program, the CPU 51 of the analysis server 32 stores (transmits), as the log data, the detailed data (including the up-to-date detailed data) of each MFP stored in the up-to-date database 33 in the log database 35 (Act 23). If the transmission of the detailed data stored in the up-to-date database 33 is completed to the log database 35 (YES in Act 24), the CPU 51 of the analysis server 32 starts data analysis processing by activating a data analysis program (Act 25).

If starting the data analysis processing, the CPU 51 determines whether a data analysis program is newly added (Act 26). If an item of the information to be newly supplied is added to the request, a processing program executed to calculate the data is added to the analysis server 32 whenever the item is added (Act 27). Moreover, the new processing program may be frequently added separately from the processing of the above-described flow. In this case, the processing of Act 26 and Act 27 are omitted.

If the data analysis processing starts, the CPU 51 analyzes the information regarding each MFP 201 from the log data stored in the log database 35 (Act 28). For example, the CPU 51 extracts the log data of the MFP to be processed, by retrieving the log database 35. The CPU 51 processes the log data (past detailed data) extracted from the log database 35 by executing the data analysis program. For example, the CPU 51 extracts the log data corresponding to one month of the MFP to be processed, as information (analysis result) to be supplied in response to the request and obtains the number of monthly printed sheets from the extracted log data. Moreover, the CPU 51 extracts the log data regarding the MFP to be processed, as information (analysis result) to be supplied in response to the request and calculates the frequency distribution of each error from the extracted log data. Then, the CPU 51 registers the analysis result calculated through the data processing in the analysis result database 34 by matching the analysis result with the information (for example, an apparatus ID) indicating each MFP (Act 29).

As described above, the analysis server collects the log data and analyzes the data asynchronously with the request from the user (service operative). Thus, if the information supply server responds to the request from the user, the information supply server can supply the information by just retrieving the analysis result obtained through the analysis processing by the analysis server 32. As a consequence, in terms of the entire management system, it is possible to considerably shorten the response time until the information is supplied in response to the request.

According to the above-described embodiment, the maintenance system can supply appropriate information to a service operative who does repairing work in response to a request without unnecessarily configuring a large scale system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A management apparatus comprising:
an information acquisition unit configured to store detailed data acquired from image processing apparatuses in an database;
an information supply unit configured to output data extracted from the database and data extracted from an analysis result database storing an analysis result of log data in response to a supply request of information regarding the image processing apparatus to be managed;
a transmission processing unit configured to store the detailed data stored in the database as the log data of the image processing apparatuses in a log database asynchronously with the supply request of the information; and
an analysis unit configured to analyze the log data stored in the log database asynchronously with the supply request of the information and storing the analysis result in the analysis result database.

2. The apparatus according to claim 1, further comprising:
a communication interface configured to execute data communication with the image processing apparatuses via a communication network,
wherein the information acquisition unit stores the detailed data acquired from the image processing apparatuses through the communication interface as up-to-date detailed data in the database.

3. The apparatus according to claim 1, further comprising:
a communication interface configured to execute data communication with a client terminal via a communication network,
wherein if receiving the supply request of the information regarding the image processing apparatuses from the client terminal through the communication interface, the information supply unit extracts the information regarding the image processing apparatuses from the database and the analysis result database according to the request and outputs the extracted data.

4. The apparatus according to claim 1, wherein the information supply unit outputs information converted from the information extracted from the database and the analysis result database so as to have a format according to the request.

5. The apparatus according to claim 1, further comprising:
a timer configured to measure a current time; and
a control unit configured to allow the transmission processing unit and the analysis unit to execute processing if the current time measured by the timer becomes an inactive time.

6. The apparatus according to claim 1, wherein the analysis unit calculates a monthly processing number for each image processing apparatus from the log data and stores the analysis result including the monthly processing number in the analysis result database.

7. The apparatus according to claim 1, wherein the analysis unit calculates a frequency distribution of each error for each image processing apparatus from the log data and stores the analysis result including information regarding the frequency distribution of each error in the analysis result database.

8. A management system comprises first and second servers,
the first server comprising:
an information acquisition unit configured to store detailed data acquired from an image processing apparatus to be managed in an database, and
an information supply unit configured to output data extracted from the database and data extracted from an analysis result database storing an analysis result of log data in response to a supply request of information regarding the image processing apparatus to be managed, and
the second server comprising:
a transmission processing unit configured to store the detailed data stored in the database as the log data of the image processing apparatus in a log database asynchronously with processing of the first server, and
an analysis unit configured to analyze the log data stored in the log database asynchronously with the processing of the first server and to store the analysis result in the analysis result database.

9. The system according to claim 8,
wherein the first server further comprising: a communication interface configured to execute data communication with the image processing apparatuses via a communication network, and
wherein the information acquisition unit stores the detailed data acquired from the image processing apparatuses through the communication interface as up-to-date detailed data in the database.

10. The system according to claim 8,
wherein the first server further comprising: a communication interface configured to execute data communication with a client terminal via a communication network, and
wherein if receiving the supply request of the information regarding the image processing apparatuses from the client terminal through the communication interface, the information supply unit extracts the information regarding the image processing apparatuses from the database and the analysis result database according to the request and outputs the extracted data.

11. The system according to claim 8, wherein the information supply unit of the first server outputs information converted from the information extracted from the database and the analysis result database so as to have a format according to the request.

12. The system according to claim 8, the second server further comprising:
a timer configured to measure a current time, and
a control unit configured to allow the transmission processing unit and the analysis unit to execute processing if the current time measured by the timer becomes an inactive time.

13. The system according to claim 8, wherein the analysis unit of the second server calculates a monthly processing number for each image processing apparatus from the log data and stores the analysis result including the monthly processing number in the analysis result database.

14. The system according to claim 8, wherein the analysis unit of the second server calculates a frequency distribution of each error for each image processing apparatus from the log data and stores the analysis result including information regarding the frequency distribution of each error in the analysis result database.

15. A data processing method in a maintenance system, comprising:
storing detailed data acquired from an image processing apparatus to be managed in an database;
outputting data extracted from the database and data extracted from an analysis result database storing an analysis result of log data in response to a supply request of information regarding the image processing apparatus to be managed;
storing the detailed data stored in the database as the log data of the image processing apparatus in a log database asynchronously with the supply request of the information; and
analyzing the log data stored in the log database asynchronously with the supply request of the information and storing the analysis result in the analysis result database.

16. The method according to claim 15, wherein the detailed data received from the image processing apparatuses through a communication network is stored as up-to-date detailed data in the database.

17. The method according to claim 15, wherein if the supply request of the information regarding the image processing apparatuses is received from a client terminal through a communication network, the information regarding the image processing apparatuses is extracted from the database and the analysis result database according to the request and the extracted data is output as a response to the request.

18. The method according to claim 15, wherein in the outputting in response to the request, information converted from the information extracted from the database and the analysis result database so as to have a format according to the request is outputted.

19. The method according to claim 15, further comprising:
measuring a current time, and
storing the log data and analyzing the log data if the measured current time becomes an inactive time.

20. The method according to claim 15, wherein in the analyzing of the log data, a monthly processing number for each image processing apparatus is calculated from the log data and the analysis result including the monthly processing number is stored in the analysis result database.
